(19) United States
(12) Patent Application Publication
(10) Pub. No.: US 2019/0145559 A1
(43) Pub. Date: May 16, 2019

(54) V-CLAMP FOR COUPLING FLANGED PIPES

(71) Applicant: Oetiker Schweiz AG, Horgen (CH)

(72) Inventor: Daniel Karlsson, Anderstorp (SE)

(21) Appl. No.: 16/247,886

(22) Filed: Jan. 15, 2019

Related U.S. Application Data
(63) Continuation of application No. PCT/EP2016/066964, filed on Jul. 15, 2016.

(51) Int. Cl. F16L 23/10

(52) U.S. Cl. CPC F16L 23/10

(57) ABSTRACT

A V-clamp for coupling circular flanges formed at mutually facing ends of two pipes to be interconnected, the clamp including at least one segment of generally V-shape cross-section adapted to surround the pipe flanges, a clamping band surrounding the at least one segment, loops provided at both ends of the clamping band, a pair of trunnions surrounded by the loops, and a tightening screw extending through the trunnions, wherein the at least one segment of generally V-shape cross-section includes two inclined surfaces configured to interact with the flanges such that a radial force exercised by the clamping band is at least partially transformed into an axial force pressing the flanges against each other.

### CROSS-REFERENCE TO RELATED APPLICATIONS

The present application is filed under 35 U.S.C. §§ 111(a) and 365(c) as a continuation of International Patent Application No. PCT/EP2016/066964, filed on Jul. 15, 2016, which application is incorporated herein by reference in its entirety.

### FIELD

The present application relates to pipe clamps, and in particular, V-clamps for pipes, and even more particularly, V-clamps for pipes having flanges formed at the ends.

### BACKGROUND

V-clamps are used for coupling circular flanges formed at the ends of two pipes to be interconnected. U.S. Pat. No. 2,941,823 (Good) discloses such a clamp which includes a clamping band and two separate semicircular segments of generally V-shape cross-section surrounded by the clamping band. The ends of the clamping band are formed with loops which surround a pair of trunnions through which a tightening screw extends. When the clamp is tightened, friction between the trunnions and the band loops tends to bend the screw as the trunnions move toward the center of the clamp. Moreover, clamping forces exerted on the pipe connection are unevenly distributed along the circumference, with the highest force occurring underneath the screw and the lowest force at the opposite location.

Thus, there is a long-felt need for a V-clamp which avoids the above deficiencies.

### SUMMARY

According to aspects illustrated herein, there is provided a V-clamp for coupling circular flanges formed at mutually facing ends of two pipes to be interconnected, the clamp comprising at least one segment of generally V-shape cross-section adapted to surround the pipe flanges, a clamping band surrounding the at least one segment, a plurality of loops provided at both ends of the clamping band, a pair of trunnions surrounded by the loops, a tightening screw extending through the trunnions, wherein the at least one segment includes two inclined surfaces configured to interact with the flanges such that a radial force exercised by the clamping band is at least partially transformed into an axial force pressing the flanges against each other, and a supporting structure arranged at an end portion of the at least one segment at a position underneath the tightening screw, wherein the supporting structure is configured to take up a part of the radial force via a surface other than the inclined surfaces when the radial force exceeds a threshold value.

According to aspects illustrated herein, there is provided a clamp for coupling flanges of two pipes to be interconnected, the clamp comprising at least one segment arranged to surround the flanges, a clamping band at least partially surrounding the at least one segment, the clamping band including a first end and a second end, a first trunnion connected to the first end and a second trunnion connected to the second end, a tightening screw extending through the first and second trunnions, wherein the at least one segment includes two inclined surfaces configured to interact with the flanges such that a radial force exercised by the clamping band is at least partially transformed into an axial force pressing the flanges against each other, and a supporting structure arranged at an end portion of the at least one segment at a position underneath the screw, wherein the supporting structure is configured to take up a part of the radial force via a surface other than the inclined surfaces when the radial force exceeds a threshold value.

The V-clamp of the invention comprises at least one segment of generally V-shape cross-section adapted to surround the pipe flanges, a clamping band surrounding the at least one segment, loops provided at both ends of the clamping band, a pair of trunnions surrounded by the loops, and a tightening screw extending through the trunnions. The at least one segment of generally V-shape cross-section has two inclined surfaces configured to interact with the flanges such that a radial force exercised by the clamping band is at least partially transformed into an axial force pressing the flanges against each other.

According to one aspect of the invention, the V-clamp further comprises a supporting structure provided at an end portion of the at least one segment at a position underneath the screw, wherein the supporting structure is configured to take up a part of the radial force via a surface other than the inclined surfaces when the radial force exceeds a threshold value. The part of the radial force bearing on the surface other than the inclined surfaces does not contribute to a further elastic deformation of the end portion of the segment concerned. Accordingly, the deformation and hence the bending stress acting on the screw is reduced. Moreover, an increase of a static friction due to increased deformation is avoided. Consequently, the transmission of tension forces to parts if the clamping band remote from the screw and the trunnions can be improved as compared to conventional devices.

Preferably, the V-clamp includes a plurality of separate segments equally spaced circumferentially, most preferably three segments.

The inventors further propose that the supporting structure includes at least one spacer disposed between at least one end of the at least one segment and the pipe flanges. A simple spacer can reliably stop further deformation and the threshold can be easily set by adapting the radial thickness of the spacer. The number of additional parts can be kept small if the supporting structure includes a single spacer element. In other embodiments of the invention, the spacer includes two separate spacer elements each between radially outer surfaces of the pipe flanges and an end of the at least one segment.

In further embodiments of the invention, the supporting structure includes a notch formed in a connecting portion between the two inclined surfaces of the least one segment of generally V-shape cross-section. This embodiment is particularly advantageous as it avoids additional components that might result in an increased complexity of the assembly.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a pipe connection with a V-clamp according to a first embodiment of the invention;

FIG. 2 is a radial cross-sectional view of the pipe connection of FIG. 1;

FIG. 3 is a detail of a view of an axial cross-section of the pipe connection of FIGS. 1 and 2 in a configuration with low radial load;

FIG. 4 is the view of the pipe connection of FIG. 3 in a tightened condition with high radial load;

FIG. 5 is a detail of an axial cross-section of a pipe connection according to a second embodiment of the invention with a supporting structure formed as a notch; and,

FIG. 6 is a radial section of the pipe connection according to a third embodiment of the invention with a supporting structure formed as a single spacer.

### DETAILED DESCRIPTION

At the outset, it should be appreciated that like drawing numbers on different drawing views identify identical, or functionally similar, structural elements. It is to be understood that the claims are not limited to the disclosed aspects.

The illustrated embodiments are only examples of how the air-conditioning device according to the invention can be configured and is not to be understood as a final restriction. The proportions of the individual elements to one another in the figures do not always correspond to the actual size ratios, since some shapes are simplified and other shapes are shown enlarged in relation to other elements for better illustration.

Furthermore, it is understood that this disclosure is not limited to the particular methodology, materials, and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

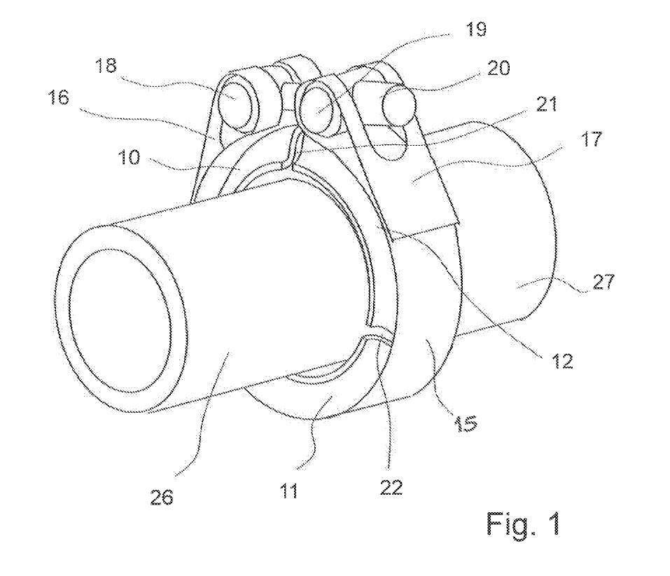

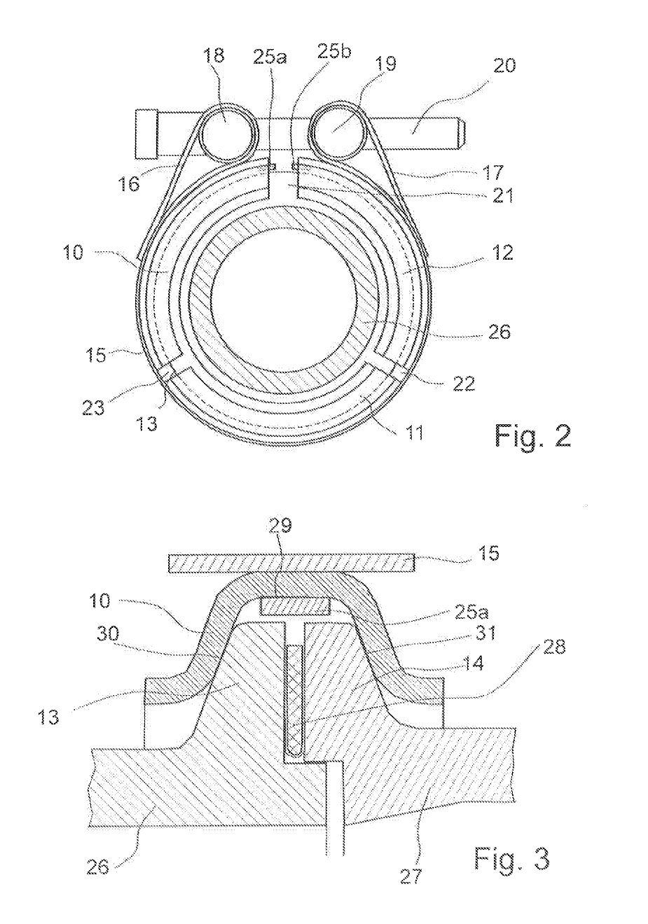

FIG. 1 is a perspective view of a pipe connection with a V-clamp according to a first embodiment of the invention. The V-clamp illustrated in FIGS. 1-3 includes three segments 10, 11, and 12 of generally V-shape cross-section adapted to surround adjacent flanges 13, 14 (see FIG. 2) of two pipes 26, 27 to be coupled by the clamp. Segments 10, 11, and 12 are equally spaced around pipe flanges 13, 14 and are surrounded by clamping band 15 that is formed at both ends with loops 16, 17 which receive a pair of trunnions 18, 19. Tightening screw 20 extends through each loop 16, 17. In the non-tightened condition shown in FIG. 1, segments 10, 11, and 12 are mutually spaced by gaps 21, 22, 23.

As illustrated in FIG. 2, the clamping band surrounds a major part of more than 80 or 90% of the circumference of pipe flanges 13, 14. When the clamp is tightened by means of screw 20, gaps 21, 22, 23 are reduced and segments 10, 11, and 12 are pressed radially onto flanges 13, 14 to clamp the two pipes 26, 27 together. A radial force is exerted onto segments 10, 11, and 12.

As illustrated in FIG. 3, segments 10, 11, and 12 include two inclined inner surfaces 30, 31 on corresponding lateral surfaces of flanges 13, 14 which are inclined at an angle similar to that of the inner surfaces of the segments 10, 11, and 12, respectively. Gasket 28 is arranged between the opposing axial end faces of flanges 13, 14. Due to the inclination, a part of the radial force exercised by the clamping band is transformed into an axial force pressing flanges 13, 14 against each other and compressing gasket 28.

Returning to FIG. 2, the radial clamping force transmitted by clamping band 15 is not homogeneous over the circumference of the clamp. Due to geometrical constraints, the clamping force shows a maximum underneath trunnions 18, 19. Moreover, inevitable static friction results in a decrease of the radial clamping force with increasing distance from screw 20 and trunnions 18, 19. Moreover, the elasticity of the system, i.e., the ratio of a radial movement of a certain point on one of segments 10, 11, and 12 and the radial force exerted on that point, is not homogeneous over the length of segments 10, 11, and 12 but rather increases towards the ends thereof.

Trunnions 18, 19 are placed in proximity to the ends of segments 10, 12 such that the region of maximum force coincides with a region of maximum elasticity. Consequently, the deformation of segments 10, 12 is particularly large in the end portions of segments 10, 12 underneath trunnions 18, 19. The latter holds for conventional clamps, whereas it holds for clamps according to the invention only as long as the radial clamping forces do not exceed a threshold value, as described in further detail below.

The coincidence of high elasticity and high force at the end portions of segments 10, 12 underneath trunnions 18, 19 leads to relatively large bending deformations in these end portions of segments 10, 12. This has various problematic consequences.

Firstly, the static friction between clamping band 15 and the outer surfaces of segments 10, 12 increase with increasing curvature of the outer surfaces. Increased static friction impairs the transmission of the clamping force to portions remote from screw 20, i.e., to the six-o-clock position at the bottom of FIG. 2.

Secondly, the bending deformation of the end portions of segments 10, 12 results in an inward swiveling motion of loops 16, 17. As a result of this swiveling motion, a static friction between the outer surfaces of trunnions 18, 19 and the inner surfaces of loops 16, 17 transmits a torque onto the trunnions, which in turn leads to a bending stress of screw 20. The amount of bending depends on the angle of the inward swiveling motion of loops 16, 17, which in turn depends on the amount of radial deformation of the end portion of segments 10, 12. The inventor has found that this bending stress is one important reason for failure of conventional V-clamps.

According to the invention, the clamp is provided with a supporting structure. In the embodiment of FIGS. 1-3, the supporting structure is comprised of two spacers 25a, 25b at end portions of the two segments 10, 12 arranged underneath screw 20.

In the range of small clamping forces illustrated in FIG. 3, spacers 25a, 25b do not influence the distribution of the clamping forces at all. The radial thickness of spacers 25a, 25b is smaller than the radial width of a gap between the radially outer rims of flanges 13, 14 and inner bottom surface 29 of segments 10, 11, and 12 on the unloaded state. However, with increasing clamping force, the width of the gap between the radially outer rims of flanges 13, 14 and inner bottom surface 29 decreases until it coincides with the thickness of spacers 25a, 25b, which then bottom down onto flanges 13, 14 and stop any further deformation of segment 10.

The force required for spacers 25a, 25b to abut both flanges 13, 14 and bottom surface 29 is defined as the threshold force and can be suitably set by varying the thickness of spacers 25a, 25b and the elasticity of the material used for segments 10, 11, and 12. The threshold force is set such that it is reached at a value of the tightening torque of screw 20 which is smaller than the target tightening torque.

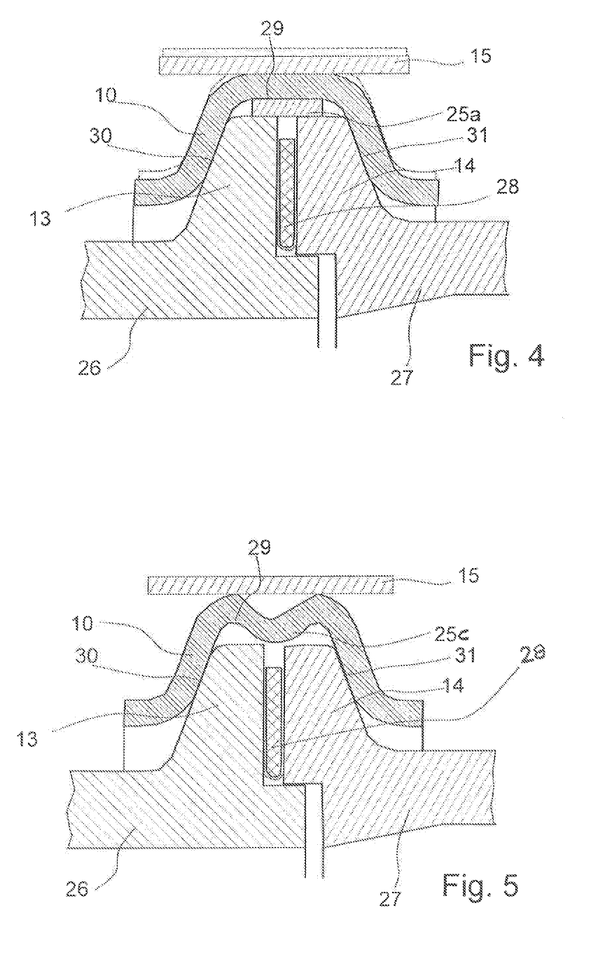

A further increase in the radial clamping force beyond the threshold value acting on segment 10 in the high-force configuration of FIG. 4 would be directly taken up by the rims of flanges 13, 14 via bottom surface 29 of segments 10, 12 and therefore does not result in a further increase of the axial force clamping the two pipes 26, 27 together. The supporting structure formed by spacers 25a, 25b therefore takes up a part of the radial force via surface 29 other than inclined surfaces 30, 31 when the radial force exceeds the threshold value.

As described above, the supporting structure according to the invention limits the bending deformation of the end portions of segments 10, 12 arranged underneath screw 20 and trunnions 18, 19. Consequently, the problematic consequences of an excessive bending deformation, i.e., the reduced force transmission to a portion of clamping band 15 remote from screw 20 and the bending stress acting on screw 20, can be limited or reduced as well. The improved force transmission results in a higher clamping force and consequently better sealing properties in the portions remote from screw 20, for a given torque of the screw. As compared to conventional V-clamps, the presence of the supporting structure reduces the axial clamping force immediately underneath trunnions 18, 19. However, the threshold force can be set such that it is still sufficient.

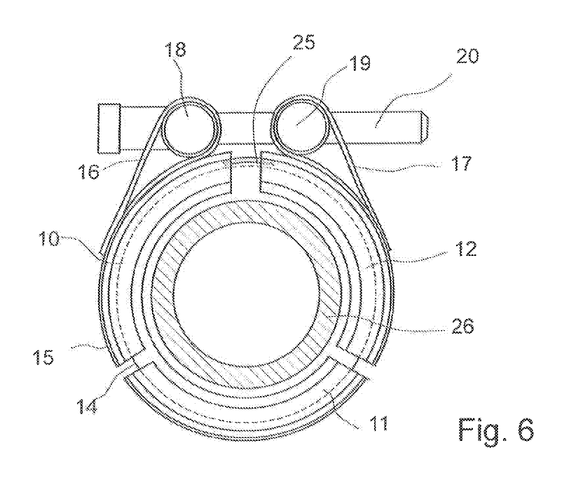

FIGS. 5 and 6 show further embodiments of the invention. The following description is limited to differences from the embodiment of FIGS. 1-4, whereas the reader is referred to the above description of the embodiment of FIGS. 1-4 for features which are unchanged. The same reference numbers are used for features with the same or similar functions in order to highlight the similarities.

In the embodiment of FIG. 5, the supporting structure is formed as protrusion 25c on bottom surface 29 in end portions of segments 10, 12 arranged underneath trunnions 18, 19. Protrusion 25c in inner surface 29 is the result of a notch embossed in an outer surface of segments 10, 11, and 12. The radial thickness of protrusion 25c, by which it protrudes over bottom surface 29, is set such that it bottoms down onto the radially outer rims of flanges 13, 14 when the clamping force reaches the threshold value. For the ease of manufacturing and assembly, protrusions 25c may be provided at both end portions of all segments even if those protrusions 25c which are not placed underneath trunnions 18, 19 will never abut to flanges 13, 14 and therefore will not have any function.

In the embodiment of FIG. 6, the supporting structure is formed as single spacer member 25, which covers gap 21 and is fitted under the end portions of segments 10, 12.

The invention is not limited to the specific combination of features described above and disclosed in the accompanying drawings. The skilled person will be able to find other combinations or sub-combinations of features in order to adapt the invention as defined in the claims to the intended use. In particular, it is possible to provide supporting structures combining notches as described in relation to FIG. 5 with spacers as disclosed in the embodiments of FIGS. 1-4 and 6.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. All of the above-described embodiments of the air-conditioning device can be used both individually and in any combination.

### LIST OF REFERENCE NUMERALS

10 Segment
11 Segment
12 Segment
13 Flange
14 Flange
15 Clamping band
16 Loop
17 Loop
18 Trunnion
19 Trunnion
20 Tightening screw
21 Gap
22 Gap
23 Gap
25a Spacer
25b Spacer
25c Protrusion
26 Pipe
27 Pipe
28 Gasket
29 Bottom surface
30 Inclined surface
31 Inclined surface

What is claimed is:

1. A V-clamp for coupling circular flanges formed at mutually facing ends of two pipes to be interconnected, the clamp comprising:
at least one segment of generally V-shape cross-section adapted to surround the pipe flanges;
a clamping band surrounding the at least one segment;
a plurality of loops provided at both ends of the clamping band;
a pair of trunnions surrounded by the loops;
a tightening screw extending through the trunnions, wherein the at least one segment includes two inclined surfaces configured to interact with the flanges such that a radial force exercised by the clamping band is at least partially transformed into an axial force pressing the flanges against each other; and,
a supporting structure arranged at an end portion of the at least one segment at a position underneath the tightening screw, wherein the supporting structure is configured to take up a part of the radial force via a surface other than the inclined surfaces when the radial force exceeds a threshold value.

2. The V-clamp as recited in claim 1, wherein the supporting structure is arranged a position underneath the trunnions.

3. The V-clamp as recited in claim 1, wherein the at least one segment comprises a plurality of separate segments equally spaced circumferentially.

4. The V-clamp as recited in claim 3, wherein the plurality of separate segments comprises three segments.

5. The V-clamp as recited in claim 1, wherein the supporting structure comprises at least one spacer disposed between at least one end of the at least one segment and the pipe flanges.

6. The V-clamp as recited in claim 5, wherein the supporting structure comprises a single spacer element.

7. The V-clamp as recited in claim 5, wherein the supporting structure includes two separate spacer elements each arranged between radially outer surfaces of the pipe flanges and an end portion of the at least one segment.

8. The V-clamp as recited in claim 1, wherein the supporting structure includes a protrusion formed on a bottom surface connecting the two inclined surfaces.

9. A clamp for coupling flanges of two pipes to be interconnected, the clamp comprising:
at least one segment arranged to surround the flanges;
a clamping band at least partially surrounding the at least one segment, the clamping band including a first end and a second end;
a first trunnion connected to the first end and a second trunnion connected to the second end;
a tightening screw extending through the first and second trunnions, wherein the at least one segment includes two inclined surfaces configured to interact with the flanges such that a radial force exercised by the clamping band is at least partially transformed into an axial force pressing the flanges against each other; and,
a supporting structure arranged at an end portion of the at least one segment at a position underneath the screw, wherein the supporting structure is configured to take up a part of the radial force via a surface other than the inclined surfaces when the radial force exceeds a threshold value.

10. The clamp as recited in claim 9, further comprising a first loop arranged at the first end and a second loop arranged at the second end.

11. The clamp as recited in claim 10, wherein the first loop at least partially surrounds the first trunnion and the second loop at least partially surrounds the second trunnion.

12. The clamp as recited in claim 9, wherein the supporting structure is arranged at a position underneath the first and second trunnions.

13. The clamp as recited in claim 9, wherein the at least one segment comprises a plurality of separate segments equally spaced circumferentially.

14. The clamp as recited in claim 13, wherein the plurality of separate segments comprises three segments.

15. The clamp as recited in claim 9, wherein the supporting structure comprises at least one spacer disposed between at least one end of the at least one segment and the pipe flanges.

16. The V-clamp as recited in claim 15, wherein the supporting structure comprises a single spacer element.

17. The V-clamp as recited in claim 15, wherein the supporting structure includes two separate spacer elements each arranged between radially outer surfaces of the pipe flanges and an end portion of the at least one segment.

18. The V-clamp as recited in claim 9, wherein the supporting structure includes a protrusion formed on a bottom surface connecting the two inclined surfaces.
